(19) United States
(12) Patent Application Publication
(10) Pub. No.: US 2003/0076778 A1
(43) Pub. Date: Apr. 24, 2003

(54) Duplication apparatus of cPCI system

(75) Inventor: Ha-Sung Lee, Kyungki-Do (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/277,665

(22) Filed: Oct. 23, 2002

(30) Foreign Application Priority Data
Oct. 23, 2001 (KR) 65352/2001

(51) Int. Cl. H04L 12/26

(52) U.S. Cl. 370/225; 710/316

(57) ABSTRACT

A method and apparatus for controlling a cPCI system includes a plurality of peripheral units which perform data communication through a PCI bus; first and second duplicate PCI boards which switch between active and standby modes based on a state of operation of the PCI boards and which arbitrate a PCI bus use privilege, and a serial bus for transmitting duplication information between the first and second PCI boards. By using the two PCI boards having the bus arbitration privilege, if one PCI board malfunctions, the other PCI board will successively arbitrate the bus use privilege of the peripheral units, so that stable service can be continuously provided.

### BACKGROUND OF THE INVENTION

1. Field of the Invention

The present invention relates to a compact peripheral component interconnect (cPCI) system, and more particularly to a duplication structure of a cPCI system.

2.

Background of the Related Art

FIG. 1 shows a related art cPCI system which includes one PCI board 11 and a plurality of peripheral apparatuses 12˜19. The peripheral apparatuses are connected to a PCI bus 20 and perform data communications under control of the PCI board.

More specifically, the PCI controller arbitrates the PCI bus to control use of a communication channel among the peripheral apparatuses. That is, when one of the peripheral apparatus 12 through 19 requests a use privilege of the PCI bus, the PCI board outputs a permission signal (GNT). Upon receipt of the permission signal (GNT), the peripheral apparatus which made the request occupies the bus and performs data communications with at least one other peripheral apparatus.

The cPCI system of the related art includes only one PCI board operated as a master. Thus, if trouble occurs in the PCI board or the board otherwise malfunctions, the peripheral apparatuses under control of the PCI board cannot perform their functions properly. As a result, the peripheral apparatuses cannot use the PCI bus and thus cannot perform a data communication service. The entire system operation is therefore not stable and reliability is degraded.

### SUMMARY OF THE INVENTION

An object of the invention is to solve at least the above problems and/or disadvantages and to provide at least the advantages described hereinafter.

It is another object of the present invention is to provide a cPCI system which operates with improved reliability compared with other systems.

It is another object of the present invention to achieve the aforementioned object by duplicating a PCI board to provide an extra measure of communications control with respect to one or more peripheral devices.

To achieve these and other objects and advantages, the present invention includes a plurality of peripheral units performing data communications through a PCI bus, first and second duplicated PCI boards for being switched to an active mode or a standby mode according to a state of the opposite PCI board and arbitrating a PCI bus use privilege, and a serial bus for transmitting duplication information between the first and second PCI boards.

In accordance with another embodiment, the present invention provides a duplication apparatus of a cPCI system which includes a plurality of peripheral units for occupying a PCI bus and performing a data communication, and first and second PCI boards for arbitrating a PCI bus use privilege of the peripheral units. The first and second PCI boards include a primary PCI for detecting a malfunction of the opposite PCI board, outputting an active signal and a bus arbitration enable signal to self-PCI board, and generating a primary clock signal, and a PCI controller for arbitrating a bus use privilege of the plurality of peripheral units according to a bus arbitration enable signal and outputting a primary clock signal as a PCI synchronous clock signal to a peripheral unit of the opposite PCI board.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a drawing illustrating a cPCI system in accordance with a related art;

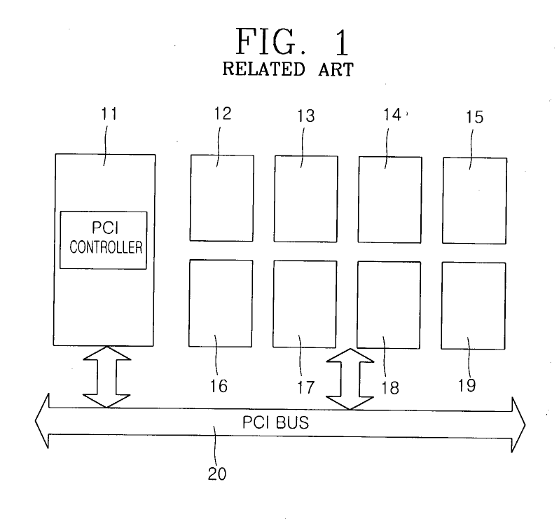

FIG. 2 is a drawing illustrating a duplication apparatus of a cPCI system in accordance with the present invention; and

FIG. 3 is a drawing illustrating a detailed construction of a duplicated PCI board of FIG. 2.

### DETAILED DESCRIPTION OF PREFERRED EMBODIMENTS

The present invention is a system and method which heightens the reliability of a PCI system by duplicating a PCI board that performs bus arbitration with respect to one or more peripheral devices that use the bus for communication purposes. The invention is advantageous in at least one respect because if trouble occurs in one PCT board, the other can be used to maintain continuous service.

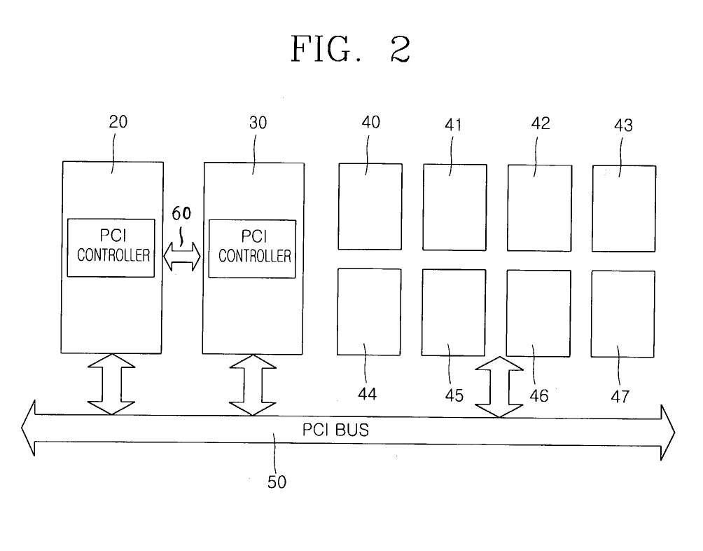

As shown in FIG. 2, a duplication apparatus of a cPCI system of the present invention includes two PCI boards 20 and 30 each having a bus arbitration privilege, and a plurality of peripheral units 40 through 47 which are connected to PCI boards 20 and 30 through a PCI bus 50. In accordance with one embodiment, one of the boards is placed in an active state to operate as a master and the other is in a standby state and operates as a slave. The PCI boards preferably transmit and receive duplication information through a serial bus 60 which includes a dual channel, and the PCI bus may be connected by a back plane.

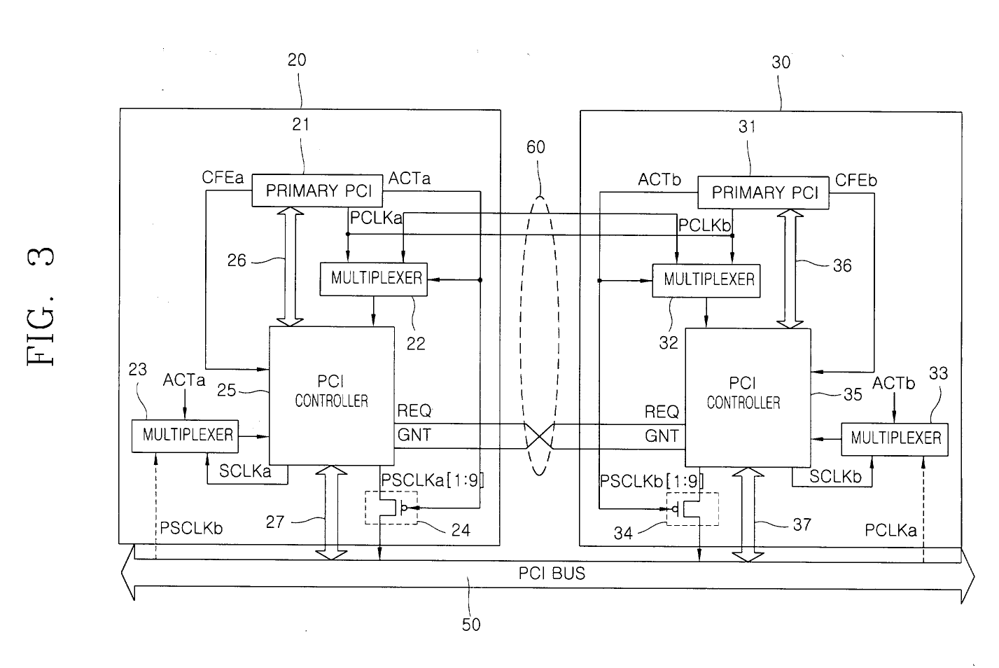

FIG. 3 is a diagram illustrating a detailed construction of PCI boards 20 and 30. The PCI boards respectively include a primary PCI (21, 31), a multiplexer (22, 32), a bus switch (24, 34), and a PCI controller (25, 35). For convenience of explanation, the suffix ‘a’ is attached to a signal of PCI board 20 and suffix ‘b’ is attached to a signal of PCI board 30.

In the PCI boards, PCI controllers 25 and 35 respectively receive a primary clock signal (PCLKa, PCLKb) and output nine PCI synchronous clock signals PSCLKa [1:9] and PSCLKb [1:9] to the peripheral units 40-47 through respective bus switches 24 and 34.

In operation, it is preferable for only one of the two PCI boards to operate as a master at any given time, i.e., both boards cannot be masters simultaneously. Thus, while one PCI board becomes active to operate as a master, the other PCI board is placed in a standby state to operate as a slave. The PCI boards are identified as master and slave states by bus arbitration enable signals (CFEa and CFEb). Active and standby states of the PCI boards are indicated by active signals (ACTa and ACTb).

In order to maintain synchronization between the duplicated PC controllers 25 and 35, multiplexers 22, 32, 23 and 33 are provided. That is, multiplexers 22 and 32 are controlled so that the same primary clock signal (PSCLKa or PSCLKb) is input into the PCI controllers 25 and 35 according to an active signal. Multiplexers 23 and 33 provide one of self-generated synchronous clock signals (SCLKa or SCLKb) or one of PCI synchronous clock signal (PSCLKb or PSCLKa) output from the opposite PCI board to PCI controllers 25 and 35 in order to synchronize the PCI synchronous clock signals (PSCLKa and PSCLKb) output from PCI controllers 25 and 35 according to an active signal. Primary PCI buses 26 and 36 are local PCI buses and secondary PCI buses 27 and 37 are PCI buses connected to an external PCI bus.

Operation of the duplication apparatus of a cPCI system constructed as described above will now be explained. In this description, it is assumed that PCI board 20 is a master and PCI board 30 is a slave.

1) Normal Operation

In case of a normal operation, PCI board 20 becomes active and operates as a master, while PCI board 30 is in a standby state and operates as a slave. When board 20 operates as a master, the primary PCI 21 outputs a low level active signal (ACTa) indicating that board 20 is in an active state, a low level bus arbitration enable signal (CFEa) indicating that board 20 is a master, and a primary clock signal (PCLKa).

The multiplexer 22 outputs a primary clock signal (PCLKa) to PCI controller 25 based on the active signal (ACTa), and the multiplexer provides a synchronous clock signal output from PCI controller 25 as a synchronous clock signal of the PCI controller 25. At this time, the bus switch 24 is turned on by the low level active signal (ACTa). Accordingly, PCI controller 25 operates as a master according to the low level bus arbitration signal (CFEa) and outputs an permission signal (GNT) to the peripheral units (40-47) requesting a bus use privilege and to the PCI board 30.

At this time, a bus use privilege request signal (REQ) and the bus use privilege permission signal (GNT) between the PCI controllers 25 and 35 are cross-connected. In addition, PCI controller 25 is synchronized with the synchronous clock signal (SCLKa) output from multiplexer 23 and outputs nine PCI synchronous clock signals (PSCLKa) [1:9] to the PCI board 30 and peripheral units 40-47 through bus switch 24.

Meanwhile, the .PCI board 30 operates as a slave. In this state, the primary PCI 31 outputs a high level active signal (ACTb) and a high-level bus arbitration enable signal (CFEb) both indicating that the PCI board 30 is a slave, and a primary clock signal (PCLKb).

The multiplexer 32 outputs the primary clock signal (PCLKa) from the primary PCI 21 to the PCI controller 35 based on the high-level active signal (ACTh), and multiplexer 33 provides the PCI synchronous clock signal (PSCLKa) transmitted from PCI board 20 as a synchronous clock signal of the PCI controller 35 based on the high-level active signal (ACTb). At this time, the bus switch 34 is turned off by the high-level active signal (ACTb). Accordingly, the PCI controller 35 operates as a-slave based on the high-level bus arbitration enable signal (CFEb) to output a bus use privilege signal (REQb) to the PCI board 20, and is synchronized with the PCI synchronous clock signal (PSCLKa) input through multiplexer 33 to perform data communications with other peripheral units 40˜47.

2) Malfunction

In addition to the above-described operation, each of primary PCIs 21 and 31 detects a heart bit periodically transmitted from the opposite PCI board, and determines whether the opposite PCI board is malfunctioning or has been dismounted.

If there is trouble in PCI board 20, primary PCI 21 transits the active signal (ACTa) and the bus arbitration enable signal (CFEa) from a low-level to a high-level, and primary PCI 31 of PCI board 30 transits the active signal (ACTb) and the bus arbitration enable signal (CFEb) from a high-level to a low-level. As a result, PCI board 30 becomes active and operates as a master, and PCI board 20 is placed in a standby state and operates as a slave.

When PCI board 30 becomes a master, multiplexer 32 outputs the primary clock signal (PCLKb) from the primary PCI 31 to the PCI controller 35 based on the low-level active signal (ACTb), and multiplexer 33 outputs the synchronous clock signal from the PCI controller 35 to the PCI controller 35. At this time, bus switch 34 is turned on by the low-level active signal (ACTb).

The PCI controller 35 operates as a master and outputs a permission signal (GNT) to peripheral units 40˜47 requesting a bus use privilege to the PCI board 20 based on the low-level bus arbitration enable signal (CFEb), and outputs the PCI synchronous clock signal (PSCLKb) synchronized with the synchronous clock signal (SCLKb) to the board 20 and the peripheral units (40˜47) through bus switch 34. At this time, the PCI board 20 operates in the same manner with the PCI board 30 in the normal operation, descriptions of which are thus omitted.

Through the switching operation as described above, even if there is trouble in a PCI board operating ve state, the PCI board in the standby state will immediately perform a function as a master and the peripheral units can be continuously controlled.

In the present invention, two PCI boards having the bus arbitration privilege are provided. Thus, if one PCI board malfunctions, the other PCI board will successively arbitrate the bus use privilege of the peripheral units, so that stable service can be performed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An apparatus for controlling a cPCI system comprising:
a PCI bus;
a plurality of peripheral units for performing data communication through the PCI bus;
first and second PCI boards for arbitrating a PCI bus-use privilege for the peripheral units; and
a serial bus for transmitting duplication information between the first and second PCI boards.

2. The apparatus of claim 1, wherein each of the first and second PCI boards comprises:
a primary PCI which outputs an active signal indicating one of an active state and a standby state, and a bus arbitration enable signal indicating one of a master state and a slave state;
a first multiplexer which selects a primary clock signal output from the primary PCI of the first PCI board or the second PCI board based on the active signal;
a second mutliplexer which selects a synchronous clock signal output from the first PCI board or the second PCI board based on the active signal;
a PCI controller which arbitrates a bus use privilege of one of the peripheral units based on the bus arbitration enable signal, and which output a PCI synchronous clock signal synchronized with an output signal of the second multiplexer; and
a bus switch which outputs the PCI synchronous clock signal outputted from the PCI controller to the PCI bus based on the active signal.

3. The apparatus of claim 2, wherein if the first PCI board is in an active state, the first multiplexer of the first PCI board outputs a primary clock signal output from the first primary PCI, and the second multiplexer selects and outputs a synchronous clock signal generated from the first PCI board.

4. The apparatus of claim 2, wherein if the second PCI board is in a standby state, the first multiplexer of the second board selects and outputs a primary clock signal from the primary PCI of the first board, and the second multiplexer selects and outputs the primary clock signal of the first PCI board.

5. An apparatus for controlling a cPCI system comprising:
a plurality of peripheral units for occupying a PCI bus and performing data communications; and
first and second PCI boards for arbitrating a PCI bus use privilege of the peripheral units,
wherein each of the first and second PCI boards comprises:
a primary PCI for detecting a malfunction of the other PCI board, outputting an active signal and a bus arbitration enable signal to self-PCI board, and generating a primary clock signal; and
a PCI controller for arbitrating a bus use privilege of the plurality of peripheral units based on a bus arbitration enable signal and outputting a primary clock signal as a PCI synchronous clock signal to a peripheral unit of the opposite PCI board.

6. The apparatus of claim 5, further comprising: a first multiplexer selectively outputting a primary clock from the self-side primary PCI and a primary clock signal output from the PCI board of the opposite side to the PCI controller based on the active signal.

7. The apparatus of. claim 5, further comprising:
a second multiplexer for selectively outputting a synchronous clock signal from the self-side PCI controller and a PCI synchronous clock output from the PCI board of the other side to the self-side PCI controller based on the active signal.

8. The apparatus of claim 5, further comprising:
a bus switch for outputting the PCI synchronous clock signal from the PCI controller to the PCI bus based on the active signal.

9. The apparatus of claim 5, wherein, in normal operation, the first PCI board becomes active and operates as a master whereas the second PCI board is in a standby state and operates as a slave.

10. The apparatus of claim 5, wherein, when trouble occurs in the first PCI board, the first PCI board is placed in a standby state and operates as a slave whereas the second PCI board becomes active and operates as a master.

11. The apparatus of claim 5, wherein the first and second PCI boards are connected through a dual channel and transmit and receive duplication information each other.

12. A duplication apparatus of a cPCI system comprising:
a primary PCI for detecting a malfunction of the second PCI board and outputting an active signal, a bus arbitration enable signal and a primary clock signal;
a PCI controller for arbitrating a bus use privilege of a plurality of peripheral units based on the bus arbitration enable signal, and outputting a PCI synchronous clock signal to the second PCI board and the peripheral units upon receipt of the primary clock signal;
a first multiplexer for selectively outputting a primary clock from the primary PCIs of the first and second PCI boards to the PCI controller based on the active signal;
a second multiplexer for outputting the synchronous clock signal from the PCI controller of the first PCI board and the PCI synchronous clock signal output from the second PCI board to the PCI controller of the first PCI board according to the active signal; and
a bus switch for outputting the PCI synchronous clock signal from the PCI controller to the PCI bus based on the active signal.

13. The apparatus of claim 12, wherein the second PCI board has the same structure with the first PCI board and is connected to the first PCI board through a serial bus which includes a dual channel

14. The apparatus of claim 12, wherein the first and second PCI boards transmit and receive duplication information through the dual channel.

15. A method for controlling a cPCI system, comprising:
detecting a fault in a first PCI board operating in an active state for arbitrating usage of a bus for a plurality of peripheral units;
placing the first PCI board in a standby state; and
transforming a second PCI board from standby state to active state for arbitrating usage of the bus for the plurality of peripheral units.

16. The method of claim 15, wherein said active state corresponds to a master state of operation, and wherein said standby state corresponds to a slave state of operation.

17. The method of claim 15, further comprising:
transmitting information from the first PCI board to the second PCI board indicative of detection of said fault, said transforming step being performed based on said information.

18. The method of claim 17, further comprising:
transmitting information through a bi-directional bus connecting the first PCI board and the second PCI board.

19. The method of claim 15, further comprising:
operating the second PCI board based on a clock signal from the first PCI board, said operating step being performed before said detecting step.

20. A method for controlling a cPCI system, comprising:
detecting, in a first PCI board operating in a standby mode, that a second PCI board operating in an active mode has been dismounted; and
placing the first PCI controller in active mode.

21. The method of claim 20, wherein the first PCI board and second PCI board arbitrate usage of a same bus for a plurality of peripheral units when operating in active mode.

22. . The method of claim 20, wherein said active state corresponds to a master state of operation, and wherein said standby state corresponds to a slave state of operatopn.
